(19) United States
(12) Patent Application Publication
(10) Pub. No.: US 2006/0019644 A1
(43) Pub. Date: Jan. 26, 2006

(54) Method for preventing personal handy-phone system handset from being reassigned with new phone number

(75) Inventors: Cheng-Shing Lai, Taipei Hsien (TW); Zhi-Long Lu, Nanking (CN); James Cao, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/893,956

(22) Filed: Jul. 20, 2004

(51) Int. Cl. H04M 3/00

(52) U.S. Cl. 455/419; 455/418

(57) ABSTRACT

The present invention discloses a method of preventing a PHS handset from being reassigned to a new phone number by installing an encryption program in a PHS handset. The encryption comprises an encryption algorithm, and such encryption algorithm can compute a coded password from a specific code, such that after the phone number is coded into the PHS handset for the first time, a user needs to run such encryption program if it is necessary to reassign a new phone number to the PHS handset. Therefore, the user needs to enter a correct password before the PHS handset can be recoded, and thus can avoid the PHS handset from being recoded without authorization.

### FIELD OF THE INVENTION

The present invention relates to personal handy-phone systems, more particularly to a method of preventing a personal handy-phone system (PHS) handset from being reassigned with a new phone number.

### BACKGROUND OF THE INVENTION

In recent years, the blooming of telecommunication industry gives rise to a low selling price of various wireless communication equipments, and thus more people use the wireless communication equipments such as the typical example of a common personal handy-phone system (PHS) handset. As the technology of the electronics industry advances, electronic products tend to be developed in a light, thin, short, and compact fashion, which has become a common trend for modern electronic telecommunication devices. The specifications for the functions and applications are upgraded continuously to meet consumer's requirements. It becomes very important to have a portable PHS handset with a compact size. Further, the common telecommunication tool, PHS handset will bring in a very profitable business opportunity of the PHS communication area, and the competition between PHS telecommunication service providers becomes severer as the allocation of the market loses its balance.

Since the PHS handset follows the standard of the Japanese digital cordless specifications, the transmission power of the PHS base station is below 32 watts, and its frequency falls in the range from 1895 MH to 1918 MH, and phone calls can be made properly at a handset moving speed of 120 Km/hr. Compared with the GSM900 and DCS1800 high power mobile phones, the charge rate of PHS handset service is lower than that that of other mobile phones (about ⅓ lower than the charge for GSM systems). Since the PHS handset is a low power device, therefore there is no issue about electromagnetic interference. Furthermore, the PHS handset offers an idle time of approximately 800 hours with a wideband networking (64K transmission rate), and the PHS handset will become a regular telephone when it is connected to an indoor telephone plug for using the phone at home, an office or a public site. The Japanese dual mode technology allows users to keep the original mobile phone number to connect to Internet for sending or receiving emails such as the Taiwan First International Telecom's “PHS Thumb Mail Service” which can use a PHS handset to send or receive emails almost the same as that of receiving and sending emails by a computer.

At present, many PHS telecommunication service providers use different combinations to promote their PHS telecommunication network services. For example, a telecommunication service provider offers a free PHS handset and at least one phone number, or sells a new model of PHS handset to users at a low price to get a new customer for to expanding the market share. The PHS telecommunication service providers charge a circuit service fee at a regular time (such as a monthly rental fee or phone charge, etc. This kind of promotion can effectively lower the entry of the PHS handsets, improve the user's loyalty to the telecommunication service provided by telecommunication service providers, and greatly increase the popularity of PHS handsets.

However, the present PHS handsets do not adopt the technology of separating the system with the card, but directly use a private system program to write the private system identifier (PSID) explicitly into the memory of the PHS handset. The process of writing the private system identifier into the memory of the handset is usually called “Coding”. Since the technology of the entry is low, it is easy to use the private system program to obtain the private system identifier, which is usually called “Decoding”. Alternatively, the private system program deletes the private system identifier, which is usually called “Erasing”, so that a new phone number can be assigned to the PHS handset again. Some users makes use of this kind of promotion offered by the PHS telecommunication service provider to get a free PHS handset or at a low price, and then use the private system program to erase the private system identifier of the PHS handset and sell the PHS handset with a new phone number to earn a price difference. That particular PHS handset is not used as originally intended for the PHS telecommunication network service promoted by the PHS telecommunication service provider, but is switched to the service provided by another PHS telecommunication service provider, and thus damaging the rights and benefits of the PHS telecommunication network service provider. If a user's handset is stolen or missing and after the handset is “erased” and “coded”, then others can use the handset, and thus damaging the rights and benefits of the user. It is definitely what users and PHS mobile phone telecommunication service providers wanted to effectively control and avoid a PHS handset from being “coded” again, so that such promotion can be achieved effectively to create a win-win situation for both the users and the PHS mobile phone telecommunication service providers.

### SUMMARY OF THE INVENTION

In view of the shortcomings of the prior arts, the inventor of the present invention conducted extensive researches and experiments and finally developed a method of preventing a personal handy-phone system (PHS) handset from being reassigned to a new phone number.

The primary objective of the present invention is to provide a method for preventing a PHS handset from being reassigned to a new phone number by installing an encryption program in a PHS handset. The encryption comprises an encryption algorithm, and such encryption algorithm can compute a coded password from a specific code, such that after the phone number is coded into the PHS handset for the first time, a user needs to run such encryption program if it is necessary to reassign a new phone number to the PHS handset. Therefore, the user needs to enter a correct password before the PHS handset can be recoded, and thus can avoid the PHS handset from being recoded without authorization.

The above and other objects, features and advantages of the present invention will become apparent from the following detailed description taken with the accompanying drawings.

### BRIEF DESCRIPTION OF THE DRAWINGS

FIG. 1 is a block diagram of the structure of the present invention.

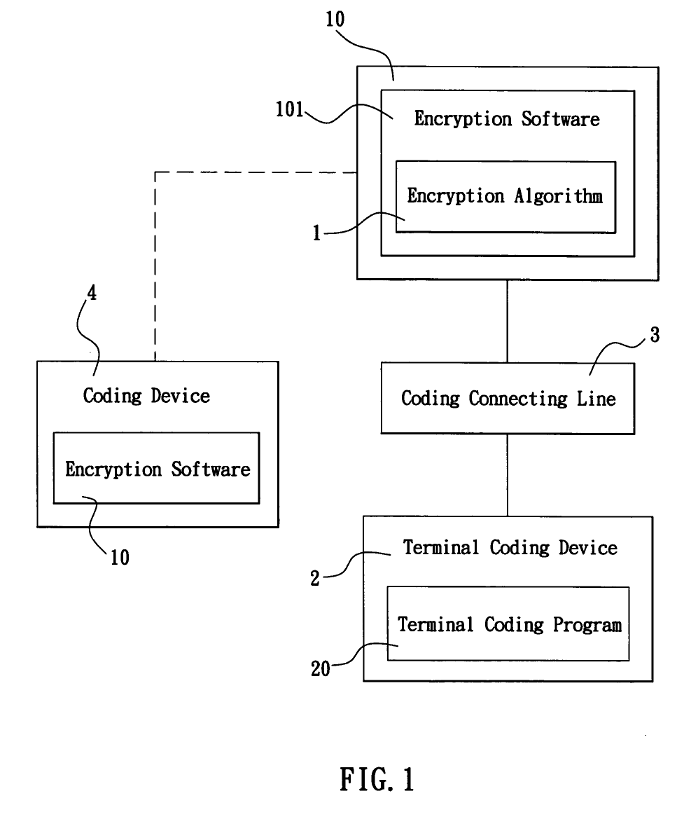

FIG. 2 is a flow chart of the procedure according to the present invention.

### DETAILED DESCRIPTION OF THE PREFERRED EMBODIMENTS

The present invention discloses a method for preventing a PHS handset from being reassigned to a new phone number. An encryption software 10 is installed in a personal handy-phone system (PHS) handset 1, and the encryption software 10 comprises at least one encryption algorithm and the encryption algorithm can compute a coded password, such that after the PHS handset 1 completes assigning a phone number to the PHS handset 1 for the first time by a terminal coding program 20, the encryption software 10 is run if the terminal coding program 20 reads the phone number of the PHS handset 1. It is necessary to enter a personal identification number (PIN) and such PIN has to match with a coding password before the PHS handset 1 can be recoded, and thus can prevent the PHS handset from being recoded without authorization.

In a preferred embodiment of the present invention, if it is necessary to recode the PHS handset 1, a terminal coding device 2, a coding connecting line 3, and a password generating device 4 are connected to the PHS handset 1 for coding the PHS handset 1. The PHS handset 1 comprises an encryption software 10 that allows repeated coding, erasing, and entering a personal identification number (PIN), and the PHS handset 1 can use the encryption software 10 to generate a coded password, and the terminal coding device 2 has a terminal coding program 20 and is connected to the PHS handset 1 by a coding connecting line 3, so that the terminal coding device 2 uses the terminal coding program to send a recoding data for recoding the PHS handset 1 via the coding connecting line 3. The password generating device 4 also comprises the encryption software 10, so that the password generating device 4 can compute the personal identification number (PIN) according to a specific code by an encryption algorithm 101, so that the person of the PHS handset 1 can obtain a new phone number and the PIN of the PHS handset 1 from the password generating device 4. Such PIN can be inputted into the PHS handset, so that a correct PIN corresponding to the coded password can be entered into the PHS handset 1, and thus the terminal coding device 2 can recode the PHS handset 1.

If the user of the PHS handset 1 does not have access to the encryption software 10, it is unable to obtain a correct PIN and recode the PHS handset 1. If the PHS telecommunication service provider can control the encryption software 10, and only if the PIN entered into the PHS handset 1 matches the coding password, then the PHS handset 1 can be recoded. Such arrangement can effectively protect the rights and benefits of the PHS telecommunication service provider. Further, if the PHS handset 1 is stolen or missing, the phone number of the PHS handset 1 cannot be recoded, and thus protecting the rights and benefits of the users.

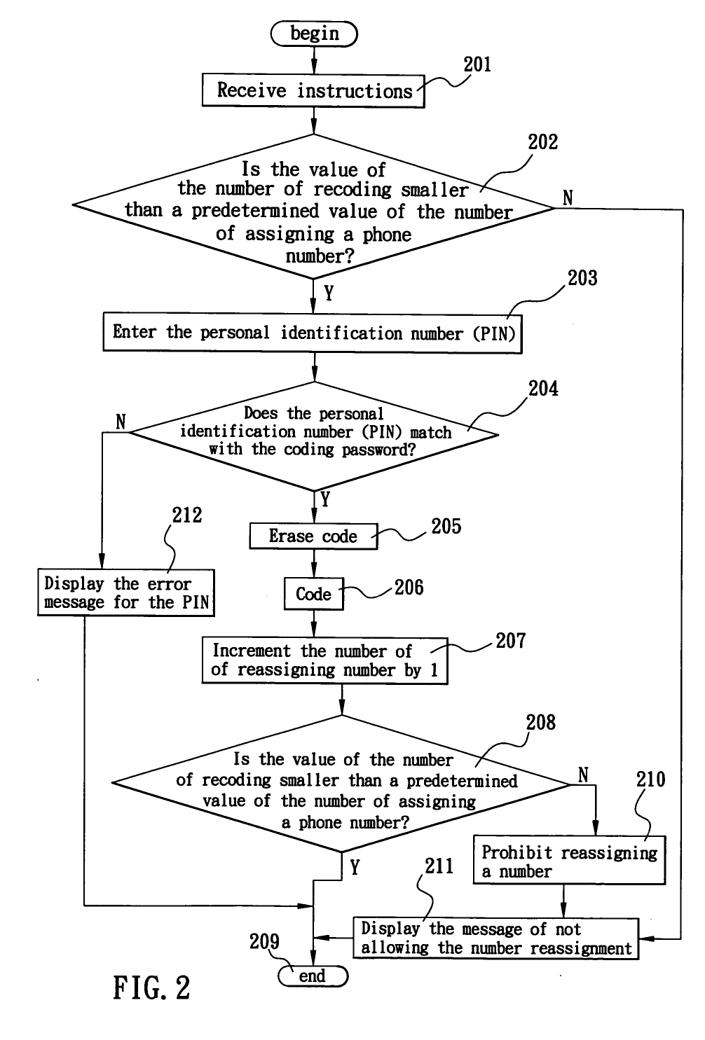

In the preferred embodiment of the present invention, the encryption software 10 further comprises a number of times of recodes and a limit number of times of recodes. Please refer to FIG. 2. After the terminal coding program 20 completes the coding of the PHS handset 1 for the first time, the PHS handset 1 will carry out the following procedure if the code of the PHS handset 1 is read by the terminal coding program 20:

(201) Receive an instruction from the terminal coding device 2.

(202) Determine whether or not the number of times of recoding is smaller than the limit number of times of recording according to the number and limit number of times of recoding; if yes, then go to Step (203), or else go to Step (211).

(203) Request a personal identification number.

(204) Determine whether or not the personal identification number matches the coded password; if yes, go to Step (205), or else go to Step (212).

(205) Erase the code first, so that the old phone number is erased from the PHS handset 1.

(206) Run the recoding to write a new phone number into the PHS handset 1.

(207) Increment the number of times of recoding by 1.

(208) Determine whether or not the number of times of recoding is smaller than the limit number of times of recording according to the number and limit number of times of recoding; if yes, then go to Step (209), or else go to Step (210).

(209) End the program.

(210) Set the PHS handset 1 to the state of prohibiting the recoding;

(211) Display the message of prohibiting the recoding, and then end the program.

(212) Display the error message regarding the personal identification number, and then end the program.

From the foregoing procedure, it is known that the encryption software 10 checks the number of times of recording after the PHS handset 1 is read by the terminal coding program 20 each time and before coding. The PHS handset 1 can be recoded, only if the number of times of recoding the PHS handset 1 is smaller than the limit number of times of recoding. Therefore, if a PHS handset manufacturer sets the limit number of times of recoding to a small number, say 1, then there is only one chance to recode the PHS handset 1. Even if the encryption software is leaked out or decoded, the PHS handset 1 only has a very small number of times of recoding.

While the invention has been described by means of specific embodiments, numerous modifications and variations could be made thereto by those skilled in the art without departing from the scope and spirit of the invention set forth in the claims.

What is claimed is:

1. A method for preventing personal handy-phone system handset from being reassigned to new phone number, having an encryption software, and said encryption software comprising at least one encryption algorithm for computing a coded password by a specific code through said encryption algorithm, thereby after said handset uses a terminal coding program to complete coding a phone number for the first time and if said terminal coding program reads said handset, the procedure carried out by said handset comprising the steps of:
running said encryption software;
requesting the entry of a personal identification number; and
allowing said handset to recode if said personal identification number matches said coded password.

2. The method of claim 1, wherein said handset requires a terminal coding device, a code connecting line, and a password generating device for said recoding when said handset is recoded.

3. The method of claim 1, wherein said encryption software comprises a number of times of recoding and a limit number of times of recoding; after said handset uses said terminal coding program to complete said recoding for the first time, and said handset is read by said terminal coding program, the procedure carried by said handset comprising the steps of:
receiving an instruction from said terminal coding device;
determining whether said number of times of recoding is smaller than said limit number of times of recoding according to said number and limit number of times of recoding;
requesting a personal identification number, if said number of times of recoding is smaller than said limit number of times of recoding;
determining whether said personal identification number matches said coding password; if yes, delete said code to erase the old phone number in said handset;
recoding and writing a new phone number into said handset;
incrementing said number of times of recoding by 1;
determining whether said number of times of recoding is smaller than said limit number of times of recoding according to said number and limit number of times of recoding; and
if yes, setting said handset to a state of prohibiting said recoding.
